(19) United States
(12) Patent Application Publication
(10) Pub. No.: US 2016/0014060 A1
(43) Pub. Date: Jan. 14, 2016

(54) NATIVE AD FORMAT FOR INTEREST-BASED CONTENT SUBSCRIPTIONS IN EMAIL

(71) Applicant: Yahoo! Inc., Sunnyvale, CA (US)

(72) Inventors: Sudharsan Vasudevan, Santa Clara, CA (US); Mayukh Bhaowal, Redwood City, CA (US); Binu Ramakrishnan, Milpitas, CA (US); Supreeth Rao, Sunnyvale, CA (US)

(73) Assignee: YAHOO! INC., Sunnyvale, CA (US)

(21) Appl. No.: 14/329,489

(22) Filed: Jul. 11, 2014

(51) Int. Cl. H04L 12/58

(52) U.S. Cl. CPC H04L 51/066; H04L 51/063; H04L 51/32; H04L 51/20

(57) ABSTRACT

Techniques are provided that include displaying an offer for an interest-based content subscription on an email application Web site, the offer being selectable and displayed in a native format of the email application, and, upon receiving an indication that the offer has been selected by a user, generating an interest-based content subscription without directing a browser application away from the email application Web site. According to some such arrangements, generating the interest-based content subscription may include contacting a third-party Web site associated with the offer, and communicating at least one of an actual identification and a disposable identification of the user to the third-party Web site. The interest-based content subscription may be limited based on at least one of a time duration and a frequency parameter.

### BACKGROUND

Currently, many users subscribe to receive email from various third-party vendors, and in recent years many such third-party vendors have built lucrative businesses based on interest-based email subscriptions. Due to their success, these third-party vendors often expend a fair amount of financial resources in their attempts to sign-up large numbers of users to their email subscription services. In contrast, email vendors (i.e., email application providers) generally have not yet capitalized on email subscription business models, although they provide much of the enabling infrastructure that allows for such lucrative third-party businesses to exist.

### SUMMARY

In a system or method, an offer element for an interest-based content subscription is displayed on an email application Web site, the offer element being selectable and displayed in a native format of the email application. Upon receiving an indication that the offer element has been selected by a user, an interest-based content subscription is generated without directing a browser application away from the email application Web site. The offer element may comprise at least one of a selectable area that is spatially adjacent to a native advertisement, a selectable area within a native advertisement, and a selectable area within a native advertisement email. Generating the interest-based content subscription may include contacting a third-party Web site associated with the offer element, and communicating at least one of an actual identification and a disposable identification of the user to the third-party Web site. The interest-based content subscription may be limited based on at least one of a time duration and a frequency parameter. The email application Web site may be configured for display on a mobile device.

In some embodiments, one or more additional offers may be determined for display based at least on the offer element selected by the user and additional user information.

In some embodiments, a subscription folder may be generated for the user, and one or more subscription emails comprising deal information related to the interest-based content subscription may be stored within the subscription folder. The deal information may be searchable based on one or more deal parameters.

In some embodiments, an alert request based on one or more deal parameters may be received, and an alert indication may be generated when at least one subscription email satisfies a condition of the alert request.

### BRIEF DESCRIPTION OF THE DRAWINGS

FIG. 1 illustrates a block diagram of a distributed computer system that can implement one or more aspects of an interest-based content subscription system or method in accordance with an embodiment;

FIG. 2 illustrates a block diagram of an electronic device that can implement one or more aspects of an interest-based content subscription system or method in accordance with an embodiment;

FIG. 3A illustrates a block diagram of an email application Web site in accordance with an embodiment;

FIG. 3B illustrates a block diagram of an email application Web site in accordance with an embodiment;

FIG. 4A illustrates a block diagram of a mobile email application Web site in accordance with an embodiment;

FIG. 4B illustrates a block diagram of a mobile email application Web site in accordance with an embodiment;

FIG. 5 illustrates a flow diagram of example operations of one or more aspects of an interest-based content subscription system or method in accordance with an embodiment;

FIG. 6 illustrates a flow diagram of example operations of one or more aspects of an interest-based content subscription system or method in accordance with an embodiment;

FIG. 7 illustrates a flow diagram of example operations of one or more aspects of an interest-based content subscription system or method in accordance with an embodiment; and

FIG. 8 illustrates a flow diagram of example operations of one or more aspects of an interest-based content subscription system or method in accordance with an embodiment.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

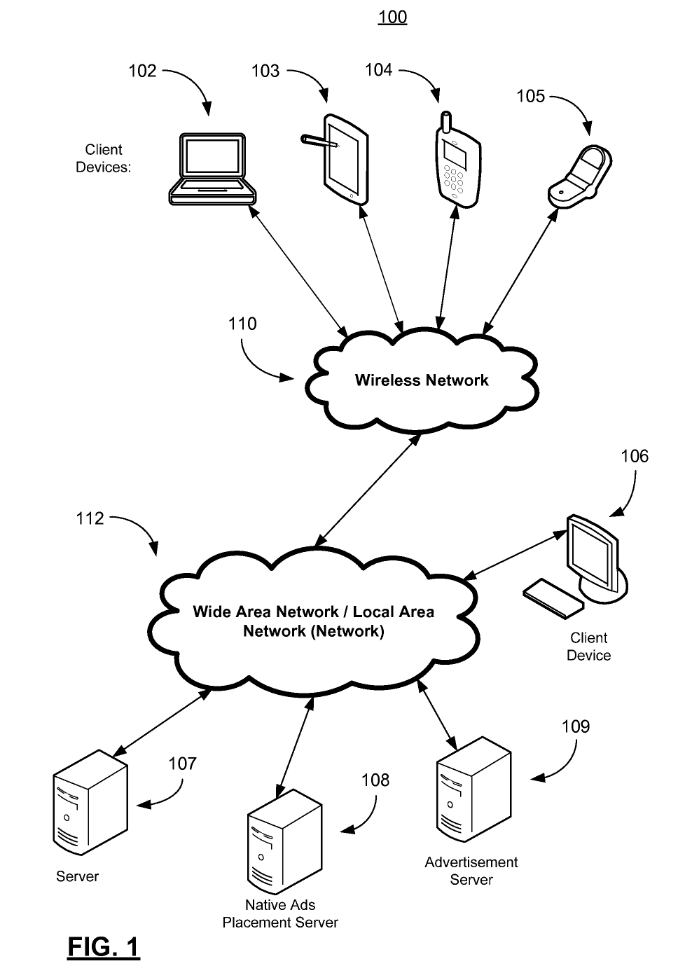

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more local area networks (“LANs”)/wide area networks (“WANs”) 112, one or more wireless networks 110, one or more wired or wireless client devices 106, mobile or other wireless client devices 102-106, servers 107-108, including native ad placement server 108, and one or more advertisement servers 109, and may include or communicate with one or more data stores or databases. Various of the client devices 102-106 may include, for example, desktop computers, laptop computers, set top boxes, tablets, cell phones, smart phones, etc. The servers 107-109 can include, for example, one or more application servers, content servers, search servers, etc.

An advertisement server can include, for example, a computer server that has a role in connection with online advertising, such as, for example, in obtaining, storing, determining, configuring, selecting, ranking, retrieving, targeting, matching, serving and presenting online advertisements to users, such as on websites, in applications, and other places where users will see them.

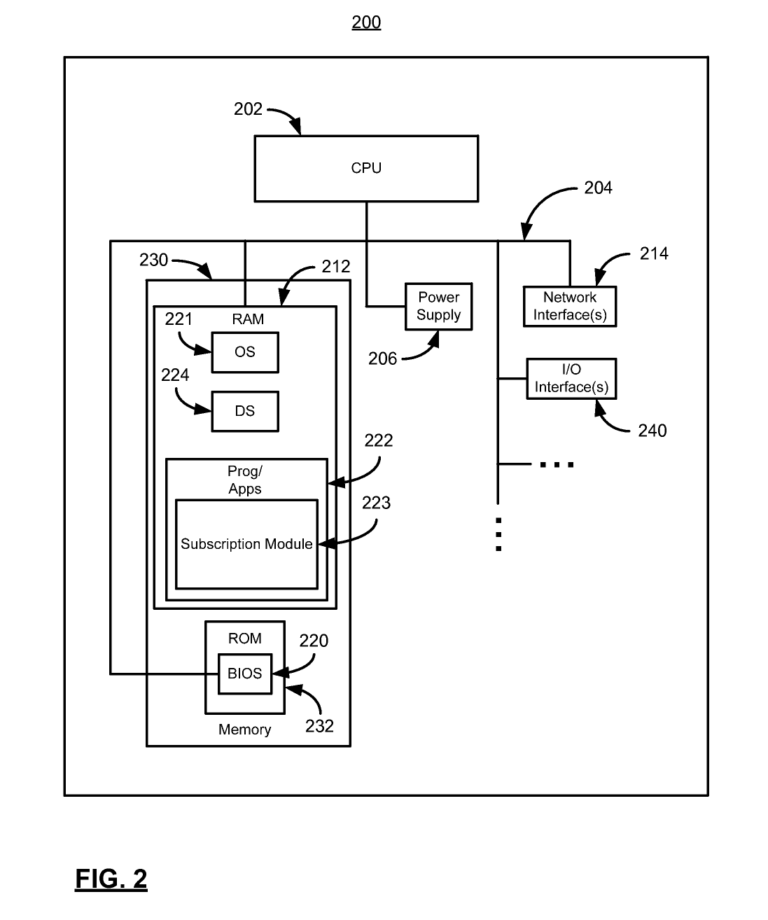

FIG. 2 illustrates a block diagram of an electronic device 200 that can implement one or more aspects of an interest-based content subscription system or method in accordance with an embodiment. Instances of the electronic device 200 may include servers, e.g. servers 107-109, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software.

The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The RAM can include an operating system 221, data storage 224, which may include one or more databases, and programs and/or applications 222, which can include, for example, software aspects of the interest-based content subscription program 223. The ROM 232 can also include BIOS 220 of the electronic device.

The interest-based content subscription program 223 is intended to broadly include or represent all programming, applications, algorithms, software and other tools necessary to implement or facilitate methods and systems according to embodiments of the invention. The elements of the subscription module 223 may exist on a single server computer, such as native ads placement server 108, or be distributed among multiple computers or devices or entities, which can include advertisers, publishers, data providers, etc.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the interest-based content subscription system or method, via a network to another device. Also, an application server may, for example, host a Web site that can provide a user interface for administration of example aspects of the interest-based content subscription system or method.

Any computing device capable of sending, receiving, and processing data over a wired and/or a wireless network may act as a server, such as in facilitating aspects of implementations of the interest-based content subscription system or method. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, UNIX, Linux, FreeBSD, etc.

A server may include, for example, a device that is configured, or includes a configuration, to provide data or content via one or more networks to another device, such as in facilitating aspects of an example interest-based content subscription system or method. One or more servers may, for example, be used in hosting a Web site, such as the Yahoo! Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example interest-based content subscription system or method. Content may include, for example, text, images, audio, video, advertisements, etc.

In example aspects of the interest-based content subscription system or method, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in example interest-based content subscription systems or methods, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in example interest-based content subscription systems or methods, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing Web sites, using a web search engine, sending and receiving messages via email, SMS, or MMS, playing games (such as fantasy sports leagues), receiving advertising, watching locally stored or streamed video, or participating in social networks.

In example aspects of the interest-based content subscription system or method, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example interest-based content subscription system or method, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

A “content delivery network” or “content distribution network” (CDN), as may be used in an example interest-based content subscription system or method, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising or advertisement selection. A “Social network” refers generally to a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network includes the person's set of direct relationships and/or indirect personal relationships. Direct personal relationships refers to relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by a “social graph” that represents each entity as a node and each relationship as an edge.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google-F), or others.

In some example interest-based content subscription systems or methods, various monetization techniques or models may be used in connection with contextual or non-search related advertising, as well as in sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bidded buying and selling of online advertisement inventory from multiple ad networks. “Ad networks” refers to companies that aggregate ad space supply from publishers and provide en masse to advertisers.

For Web portals, such as Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a Web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

Some embodiments of the invention relate, directly or indirectly to native advertisements. Native advertisements can include, among other things, advertisements, such as online advertisements, that, to some degree, blend, match, flow with, or are in some ways similar to the context of the user's experience, such as may include non-advertising items or content. In some embodiments, Native ads can include, among other things, formats that may match or be similar to the form or function of the user experience in which the ad is presented. In some embodiments, native advertisements may seem less obtrusive or intrusive to the user or to the user's experience. Some embodiments include elements or advertisements that are native, native elements or native advertisements, while other embodiments do not.

Various embodiments herein provide an interest-based content subscription system or method that allows users to subscribe to interest-based content within their email application, and without having their browser application redirected away from an email application Web site to a third-party Web site. In some embodiments, a selectable offer element for an interest-based content subscription is displayed on an email application Web site, such as an email application Web site configured for display on a desktop computer or on a mobile device (i.e., a mobile email application Web site). A user may subscribe to interest-based content by selecting an offer element, e.g., by clicking on a subscribe button associated with an advertisement. In order to provide a user experience that is as integrated as possible with that of the email application Web site, an offer element may be displayed as a selectable area spatially adjacent to a native advertisement, a selectable area within a native advertisement, or a selectable area within a native advertisement email (e.g., within a sponsored email). Upon receiving an indication that an offer element has been selected by a user, an interest-based content subscription is generated without directing the user's browser application away from the email application Web site. In some embodiments, one or more additional subscription offers may be determined for display based at least on the offer element selected by the user and additional user information, e.g., background information, social network connections, information collected from the user's email inbox determined to suggest user interests, email subject headers, received ads and other content.

In some embodiments, generating the interest-based content subscription may include contacting a third-party Web site associated with an offer element, and communicating at least one of an actual identification and a disposable identification of the user to the third-party Web site. For example, a user's email identification may be kept private through the use of a disposable email identification, such as a temporary email address.

In some embodiments, a subscription folder may be generated upon the selection of an offer element by a user. Received subscription emails comprising deal information related to the interest-based content subscription may be stored in the subscription folder (or a sub-folder of the subscription folder), thus decreasing the amount of email messages stored in other email application folders, such as the user's inbox. In some embodiments, both the subscription to the interest-based content and the subscription folder to receive subscription emails may be generated in response to a (one-click) selection of an offer element by a user.

In some embodiments, the subscription folder may be searchable based on one or more deal parameters. For example, a user may search the subscription emails for refined/targeted deals, or offers such as discounts, coupons, group deals, etc., based on one or more deal parameters. A user may also save the one or more deal parameters for future (e.g., periodic) searches. In some embodiments, a search may be extended beyond the subscription folder to the Web for a categorized search (e.g., a shopping category search) based on the one or more deal parameters.

In some embodiments, a subscription may be limited based on time duration and frequency parameters. For example, a user may receive “daily deals” type subscription emails based on one or more time duration or frequency parameters. For example, a user who is interested in a low cost flight to New York during the summer may wish to subscribe only during a relevant time period (e.g., only during the weeks prior to the desired date(s) for the flight). Moreover, the user may only wish to receive subscription emails regarding flight deals to New York at a desired frequency, such as once a day, every other day, once a week, once a month, etc. In some embodiments, a time duration or parameter may be automatically set without input or selection from a user, or may be set globally and utilized repeatedly without input or further input from the user in particular cases.

In some embodiments, an alert request based on one or more deal parameters may be received, and an alert indication may be generated when at least one subscription email satisfies a condition of the alert request. For example, a user may request an alert for when a received subscription email includes a deal for a flight to New York that satisfies one or more deal parameters (e.g., a desired date) set as conditions for the alert.

Some embodiments promote, enhance, or allow monetization, or better monetization, of email properties or other properties. For example, in some embodiments, an advertiser (or other content provider) may arrange for elements or ads to be served on, for example, an email property. For example, the advertiser or content provider may pay in connection with such, and this may provide revenue that may be split between other involved entities, such as, for example, a publisher, email application provider, content or ad serving entity or facilitator, or data provider. In various embodiments, various revenue models may be used in this connection, including often used models such as pay per impression, pay per click, etc. However, in some embodiments, less common models, or models that may be unique to embodiments of the invention may be used, such as, for example, pay per subscription.

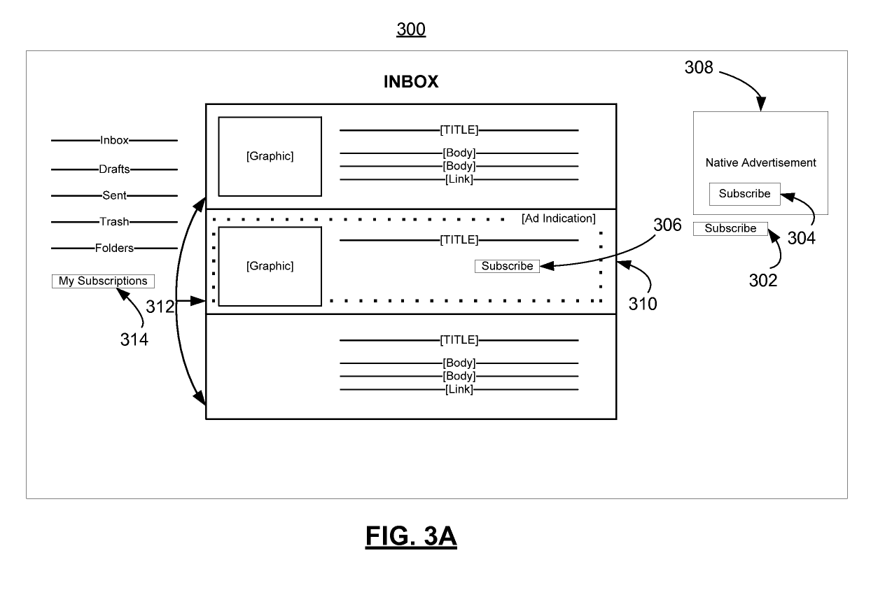

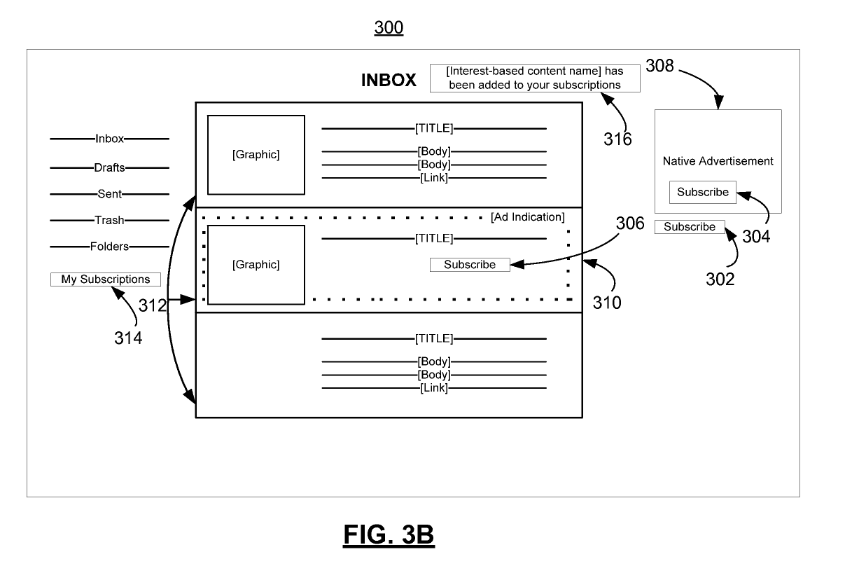

FIG. 3A illustrates a block diagram of an email application Web site in accordance with an embodiment. FIG. 3A provides a simplified illustration of a portion of an email application Web site 300 including various interest-based subscription offer elements 302, 304, 306 that a user may select to subscribe to interest-based content without their browser being directed away from the email application Web site to a third-party Web site.

In order to provide a user experience that is as integrated as possible with that of the email application Web site, an offer element may enrich an existing native advertisement, or alternatively, comprise a new native advertisement format. As described above, a native advertisement can, of course, vary, but may, for example, include a textual indication that is an ad, which may also be a link, etc., as well as one or more visual cues, which may, in some embodiments, distinguish or subtly distinguish the native ad from other content items while not breaking abruptly or drastically from the format of the other content items.

For example, the offer element 302 is displayed as a selectable area that is spatially adjacent to a native advertisement 308, such that it is meant to be associated with the native advertisement without altering the preexisting ad format or function.

In another example, the offer element 304 is displayed as a selectable area within the native advertisement 308. As such, the offer element 304 may enrich an existing native ad 308 or comprise a new native ad format that is both integrated into the email application's user experience and that can be selected without directing a user's browser away from the email application Web site to a third-party Web site.

In yet another example, offer element 306 appears as a selectable area within a native advertisement email 310. For example, the offer element 306 may be displayed as a selectable area of a sponsored email 310 within a user's inbox 312.

It should be noted that while FIG. 3A depicts several different types of offer elements, the variety shown is for illustrative purposes only. Email application Web site 300 may include any number offer elements and the types of offer elements illustrated herein are not meant to be limiting. One skilled in the art will appreciate that many other variations within the scope of the embodiments are possible.

FIG. 3B illustrates a block diagram of an email application Web site in accordance with an embodiment. FIG. 3B provides a simplified illustration of a portion of an email application Web site 300 upon receiving an indication that, e.g., one of offer elements 302, 304 or 306 has been selected by a user. As discussed above, when a user selects one of offer elements 302, 304 or 306, an interest-based content subscription is generated without directing the user's browser application away from the email application Web site. For example, a subscription folder 314 may be generated to store received subscription emails comprising deal information related to the interest-based content subscription, thus decreasing the amount of email messages stored in other email application folders, such as the user's inbox 312. Alternatively, if a subscription folder already exists, a sub-folder of the subscription folder may be created for a specific subscription or type of subscription (e.g., “daily deals”). In some embodiments, both the subscription to the interest-based content and the subscription folder to receive subscription emails may be generated in response to a single (i.e., “one-click”) selection of an offer element by a user. In some embodiments, a confirmation message 316 may be displayed when a subscription has been generated. For example, a confirmation message such as “[Interest-based content name] has been added to your subscriptions” may inform a user that a subscription for certain interest-based content has been successfully generated and that a subscription folder or sub-folder has been created (if one does not already exist) to receive subscription emails.

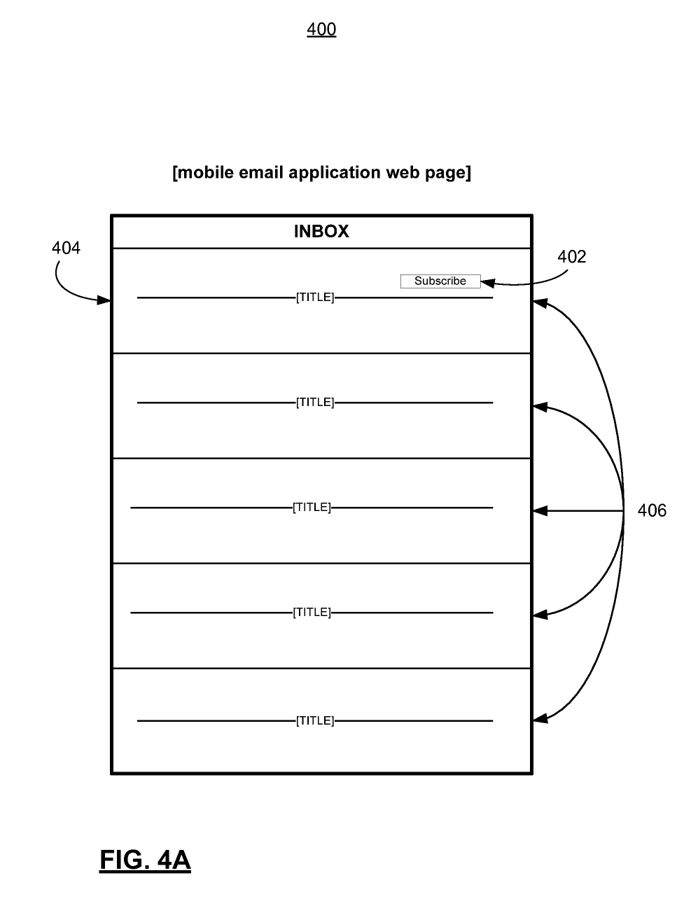

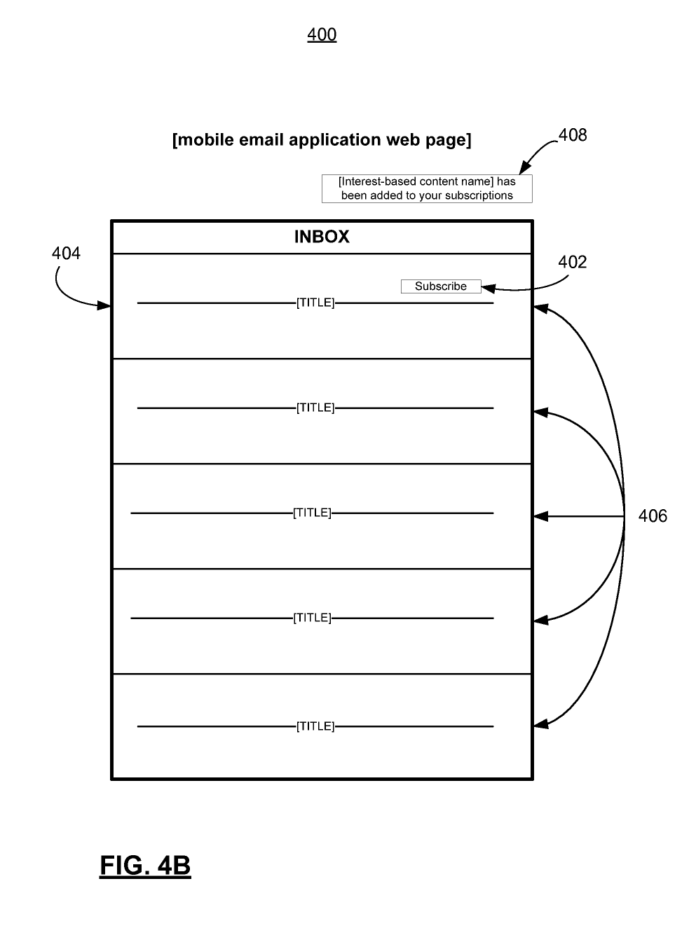

FIG. 4A illustrates a block diagram of a mobile email application Web site in accordance with an embodiment. FIG. 4A provides a simplified illustration of a portion of a mobile email application Web site 400 including an interest-based subscription offer element 402 that may be selected to subscribe to interest-based content without directing a mobile browser application away from the email application Web site to a third-party Web site. For example, offer element 402 is displayed as a selectable area within a native advertisement email 404 of inbox 406, such that it provides a user experience that is integrated with that of the mobile email application Web site. Also, while not depicted for the sake of simplicity, various other types of offer elements (e.g., selectable areas that are spatially adjacent to native advertisements, selectable areas within native advertisements, etc. as depicted in FIGS. 3A & 3B above) are possible and mobile email application Web site 400 may include any number and type of such offer elements. As such, one skilled in the art will appreciate that the elements illustrated herein are not meant to be limiting, and that many other variations within the scope of the embodiments are possible.

FIG. 4B illustrates a block diagram of a mobile email application Web site in accordance with an embodiment. FIG. 4B provides a simplified illustration of a portion of an mobile email application Web site 400 upon receiving an indication that offer element 402 has been selected by a user. When a user selects the offer element 402, an interest-based content subscription is generated without directing the user's mobile browser application away from the mobile email application Web site. For example, a subscription folder (not shown) may be generated to store received subscription emails comprising deal information related to the interest-based content subscription, thus decreasing the amount of email messages stored in other email application folders, such as the user's inbox 406. Alternatively, if a subscription folder already exists, a sub-folder of the subscription folder may be created for a specific subscription or type of subscription. In some embodiments, both the subscription to the interest-based content and the subscription folder to receive subscription emails may be generated in response to a one-click selection of an offer element by a user. In some embodiments, a confirmation message 408 may be displayed when a subscription has been generated. For example, a confirmation message such as “[Interest-based content name] has been added to your subscriptions” may inform a user that a subscription for certain interest-based content has been successfully generated and that a subscription folder or sub-folder has been created (if one does not already exist) to receive subscription emails.

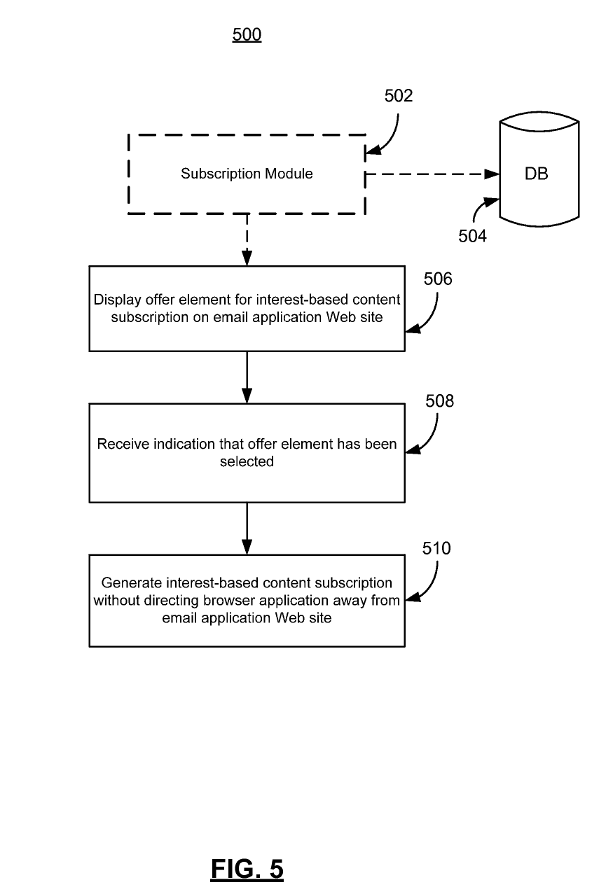

FIG. 5 illustrates a flow diagram 500 of example operations of one or more aspects of a system or method according to an embodiment, including a subscription module 502 that can send, receive and store information in one or more databases 504.

At step 506, the subscription module 502 displays an offer element, such as depicted by the offer elements 302, 304 and 306 (or offer element 402) for an interest-based content subscription on an email application Web site (e.g., email application Web site 300 or mobile email application Web site 400), the offer element being selectable and displayed in a format native to the email application.

At step 508, the subscription module 502 receives an indication that the offer element has been selected by a user. For example, the user may click on one of subscription offers 302, 304, 306 or 402.

At step 510, the subscription module 502 generates an interest-based content subscription without directing a browser application away from the email application Web site. As such, the subscription module 502 may enable a one-click experience for subscribing to interest-based content, wherein a user may subscribe to content without having to leave their email application for a third-party Web site.

In some embodiments, the subscription module 502 may direct one or more additional emails or targeted advertisements to the user based on the interest-based content subscription. Such items, among other items in some embodiments, can include or incorporate, for example, deals, discount coupons, group deals, etc. The subscription module 502 may also recommend additional interest-based content subscriptions based on a user's existing subscriptions or subscription trends (e.g., if a user subscribes to content from Best Buy, the subscription module 502 might recommend content from Fry's or Amazon based on the user's subscription trends).

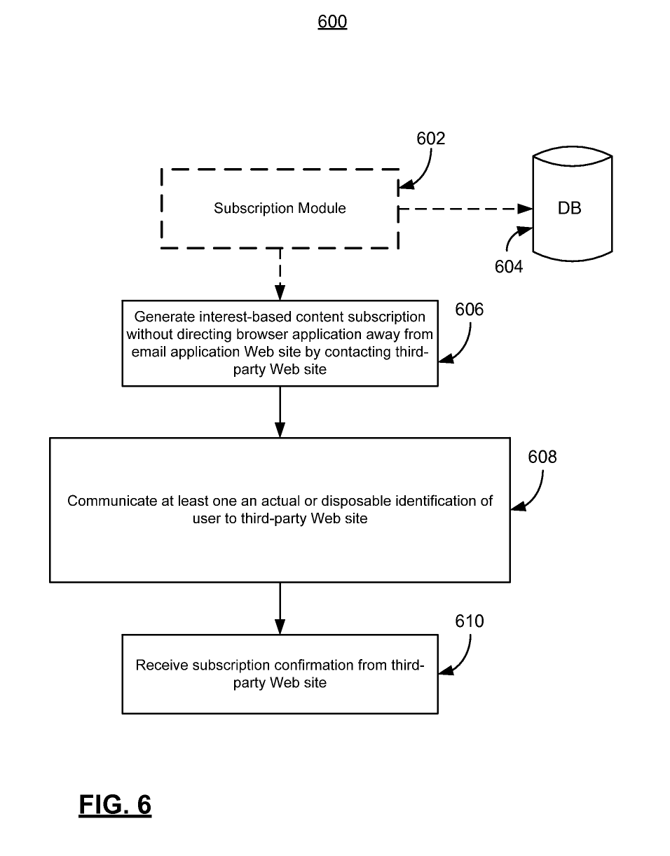

FIG. 6 illustrates a flow diagram 600 of example operations of one or more aspects of a system or method according to an embodiment, including a subscription module 602 that can send, receive and store information in one or more databases 604.

At step 606, the subscription module 602 may generate an interest-based content subscription without directing a browser application away from the email application Web site by contacting a third-party Web site associated with the offer.

At step 608, the subscription module 602 communicates at least one of an actual identification and a disposable identification of the user to the third-party Web site. In some embodiments, a user's email identification may be kept private through the use of a disposable email identification, such as a temporary email address. For example, in order to prevent a security breach, the subscription module 602 may use a cross-site request forgery (XSRF) security token string in communications with the third-party Web site to, for example, initiate the subscription via a proxy identification on behalf of the user. At step 610, the subscription module 602 receives a subscription confirmation from the third-party Web site indicating that a subscription has been successfully activated for the user.

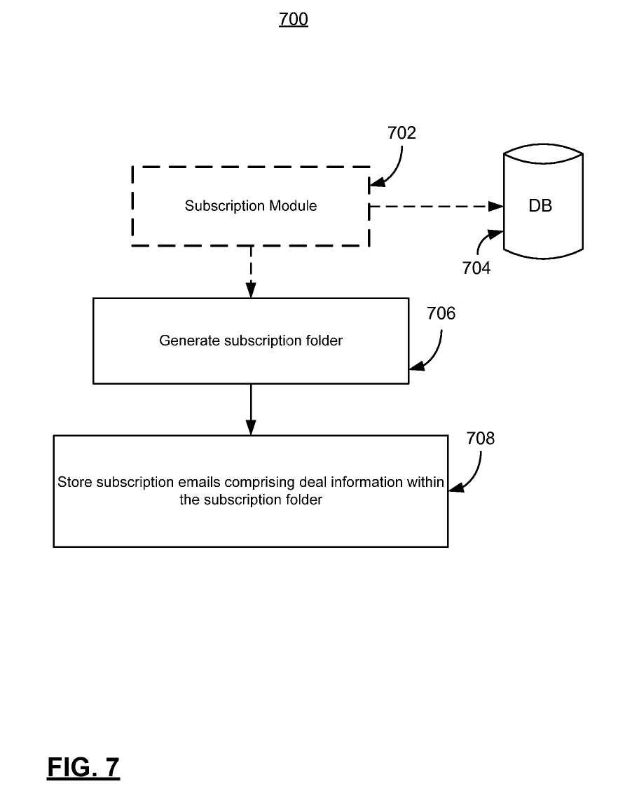

FIG. 7 illustrates a flow diagram 700 of example operations of one or more aspects of a system or method according to an embodiment, including a subscription module 702 that can send, receive and store information in one or more databases 704.

At step 706, the subscription module 702 generates a subscription folder (if it does not already exist) for the user. For example, the subscription module 702 may generate a subscription folder (e.g., “my subscriptions”) as part of the user's folder list within the email application. An associated filter or rule may then direct subscription email received from the third-party Web site to the subscription folder. Therefore, the subscription module 702 may direct any subscription email from the third-party website to the subscription folder rather than to, for example, the user's inbox. In addition, the subscription module 702 may move existing emails related to the subscription to the subscription folder. In some embodiments, the interest-based content subscription may be limited based on a time duration or frequency parameters. For example, subscriptions that are time-sensitive may be limited to stop after ‘n’ number of days as determined by the user such that emails or notifications related to the interest-based content subscription will not continue to arrive indefinitely. Moreover, the subscription module 702 may provide an unsubscribe option within the subscription folder for when a user no longer wishes to receive email from the third-party Web site.

At step 708, the subscription module 702 stores one or more subscription emails comprising deal information related to the interest-based content subscription within the subscription folder. In some embodiments, the subscription emails may be searchable based on one or more deal parameters. For example, the subscription emails may be searchable based on a user's stated interest in certain items or things within a time period (e.g., a smartphone from a particular manufacturer that costs between 200 to $250 by next week). Moreover, in some embodiments the user may subscribe to a search result, such that the subscription module 702 may store emails related to the search result within the subscription folder (e.g., as a new subscription).

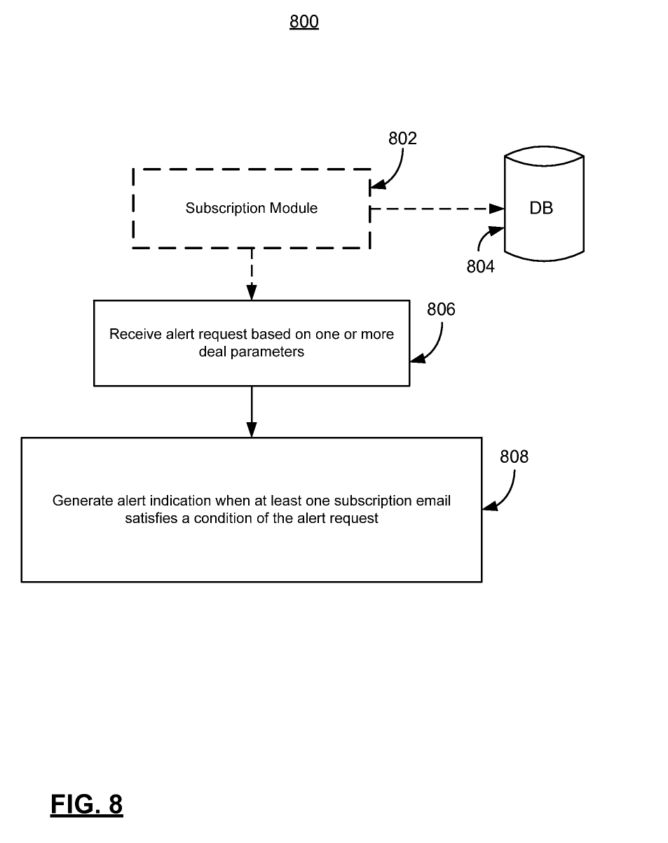

FIG. 8 illustrates a flow diagram 800 of example operations of one or more aspects of a system or method according to an embodiment, including a subscription module 802 that can send, receive and store information in one or more databases 804.

At step 806, the subscription module 802 may receive an alert request based on one or more deal parameters. For example, if the user is searching for deals regarding shoes, the subscription module 802 may allow a user to create an alert based on the search term ‘shoes’. In some embodiments, the subscription module 802 may prompt a user to create an alert based on a previous user search (e.g., “Do you want to create an alert for ‘shoes’ in My Subscriptions?”). Moreover, the subscription module 802 may direct one or more additional emails or targeted advertisements to the user based on an alert request.

At step 808, the subscription module 802 generates an alert indication when at least one subscription email satisfies a condition of the alert request. For example, the subscription module 802 may generate a message for display at log-in when a subscription email satisfies the alert condition (e.g., “New deal alert for Shoes”) or, in a mobile context, generate a text message notification directed to a user's mobile device when an alert condition is satisfied. The user may then be directed to the subscription folder to view the relevant subscription email.

While the invention is described with reference to the above drawings, the drawings are intended to be illustrative, and the invention contemplates other embodiments within the spirit of the invention.

1. A system, for offering an interest-based content subscription via an email application, the system comprising one or more processors and a non-transitory storage medium comprising program logic for execution by the one or more processors, the program logic comprising:
a subscription module configured to:
display an offer element for an interest-based content subscription on an email application Web site; and
upon receiving an indication that the offer element has been selected by a user, generate an interest-based content subscription without directing a browser application away from the email application Web site.

2. The system of claim 1, wherein the offer element comprises at least one of a selectable area that is spatially adjacent to a native advertisement, a selectable area within a native advertisement, and a selectable area within a native advertisement email.

3. The system of claim 1, wherein generating the interest-based content subscription includes:
contacting a third-party Web site associated with the offer element; and
communicating at least one of an actual identification and a disposable identification of the user to the third-party Web site.

4. The system of claim 1, wherein the interest-based content subscription is limited based on at least one of a time duration and a frequency parameter.

5. The system of claim 1, wherein the subscription module is further configured to determine one or more additional offers for display based at least on the offer element selected by the user and additional user information.

6. The system of claim 1, wherein the email application Web site is configured for display on a mobile device.

7. The system of claim 1, wherein the subscription module is further configured to:
generate a subscription folder for the user; and
store one or more subscription emails comprising deal information related to the interest-based content subscription within the subscription folder, wherein the deal information is searchable based on one or more deal parameters.

8. The system of claim 7, wherein the subscription module is further configured to:
receive an alert request based on one or more deal parameters; and
generate an alert indication when at least one subscription email satisfies a condition of the alert request.

9. A method comprising:
displaying an offer element for an interest-based content subscription on an email application Web site, the offer element being selectable and displayed in a native format of the email application; and
upon receiving an indication that the offer element has been selected by a user, generating an interest-based content subscription without directing a browser application away from the email application Web site.

10. The method of claim 9, wherein the offer element comprises at least one of a selectable area that is spatially adjacent to a native advertisement, a selectable area within a native advertisement, and a selectable area within a native advertisement email.

11. The method of claim 9, wherein generating the interest-based content subscription includes:
contacting a third-party Web site associated with the offer element; and
communicating at least one of an actual identification and a disposable identification of the user to the third-party Web site.

12. The method of claim 9, wherein the interest-based content subscription is limited based on at least one of a time duration and a frequency parameter.

13. The method of claim 9, further comprising determining one or more additional offers for display based at least on the offer element selected by the user and additional user information.

14. The method of claim 9, wherein the email application Web site is configured for display on a mobile device.

15. The method of claim 9, further comprising:
generating a subscription folder for the user; and
storing one or more subscription emails comprising deal information related to the interest-based content subscription within the subscription folder, wherein the deal information is searchable based on one or more deal parameters.

16. The method of claim 15, further comprising:
receiving an alert request based on one or more deal parameters; and
generating an alert indication when at least one subscription email satisfies a condition of the alert request.

17. A non-transitory computer readable storage medium tangibly storing computer program instructions capable of being executed by a computer processor, the computer program instructions defining the steps of:
displaying an offer element for an interest-based content subscription on an email application Web site, the offer element being selectable and displayed in a native format of the email application; and
upon receiving an indication that the offer element has been selected by a user, generating an interest-based content subscription without directing a browser application away from the email application Web site,
wherein generating the interest-based content subscription includes:
contacting a third-party Web site associated with the offer element; and
communicating at least one of an actual identification and a disposable identification of the user to the third-party Web site.

18. The non-transitory computer readable storage medium of claim 17, wherein the computer program instructions further define the step of determining one or more additional offers for display based at least on the offer element selected by the user and additional user information.

19. The non-transitory computer readable storage medium of claim 17, wherein the computer program instructions further define the steps of:
generating a subscription folder for the user; and
storing one or more subscription emails comprising deal information related to the interest-based content subscription within the subscription folder, wherein the deal information is searchable based on one or more deal parameters.

20. The non-transitory computer readable storage medium of claim 19, wherein the computer program instructions further define the steps of:
receiving an alert request based on one or more deal parameters; and
generating an alert indication when at least one subscription email satisfies a condition of the alert request.
